(19) United States
(12) Patent Application Publication
(10) Pub. No.: US 2008/0276872 A1
(43) Pub. Date: Nov. 13, 2008

(54) Foldable pet bed

(76) Inventor: Shiuan Kuen Chern, Arcadia, CA (US)

Correspondence Address: DAVID AND RAYMOND PATENT FIRM, 108 N. YNEZ AVE., SUITE 128, MONTEREY PARK, CA, 91754, US

(21) Appl. No.: 11/801,470

(22) Filed: May 9, 2007

(51) Int. Cl. A01K 29/00

(52) U.S. Cl. 119/28.5

(57) ABSTRACT

A foldable pet bed includes a foldable pet bed top, and a foldable bed frame including two elongated side reinforcing members, two leg frames, means for retaining the leg frames at a folded position, and two pivot joints. The pet bed top has a size adapted for a pet resting thereon and includes a first supporting panel and a second supporting panel aligned in an edge-to-edge manner to form a top resting surface for the pet resting thereon. The elongated side reinforcing members are extended underneath the pet bed top along two longitudinal sides thereof respectively. The leg frames are pivotally coupling between the two side reinforcing members to pivotally fold between an unfolded position and the folded position, in which the leg frames are pivotally folded to rest underneath the pet bed top.

### BACKGROUND OF THE INVENTION

1. Field of Invention

The present invention relates to folding furniture, and more particularly to a foldable pet bed comprising a foldable bed frame which allows the foldable pet bed to be folded into a compact size, and can be more conveniently carried as compared to conventional pet bed.

2. Description of Related Arts

Conventional pet beds are usually bulky in size and difficult to carry around, so that when pets owners need to travel around, they are left with two options. First they may leave their pets at home and ask someone to take care of them. Second, they may actually carry the pets with them, usually with a specific carrying cage. The former option imparts substantial inconvenience to pet owners. The latter option, though allowing the pet owners to carry their pets with them, does not supported by adequate traveling accessories (such as an optimal pet bed) so that the pets may be exposed to an adverse sleeping environment.

In order to overcome this problem, conventional foldable pet beds have been developed in which they are usually utilized by pet owners to provide an optimal environment for his/her beloved pet to sleep or rest thereon. Foldable pet beds can also be carried around for travel purposes (e.g. the owner decides to bring his/her dog to a picnic trip with the foldable pet bed). When the pet beds are not in used, they can be easily folded and stored in a closet or garage in order for saving storage space.

A conventional foldable pet bed usually comprises a foldable pet bed frame having a pair of runners on the sides with a pair of bed leg frames pivotally mounted on the runners in a foldable manner, a pet bed top comprising a supporting board, which has a cushioning mattress provided thereon, supported by the foldable pet bed frame, and perhaps a handle strap for carrying the bed when it is folded.

A main disadvantage of this conventional foldable pet bed is that it is generally hard or complicated to fold. In particular, the pet bed top is not usually foldable so that even when the pet bed frame can be compactly folded, the overall size of the foldable pet bed cannot be reduced to its minimum. Another disadvantage is that the conventional foldable pet bed is difficult to carry around when it is folded. A gripping portion is usually missing from the foldable pet bed which allows him/her to carry the bed when it is folded. Finally, the conventional foldable pet bed has a high chance of accidental collapsing when heavy pets (e.g. a big dog) are moving around or jumping on the bed.

### SUMMARY OF THE INVENTION

A main object of the present invention is to provide a foldable pet bed which is capable of being overlapped folded into a compact structure for easy carrying and transportation, so that pet owners are able to conveniently provide an optimal resting environment for their pets when they are traveling around by using the foldable bed pets of the present invention.

Another object of the present invention is to provide a foldable pet bed comprising a foldable bed top which is adapted to overlappedly fold to substantially reduce an overall size of the entire pet bed, so as to allow the present invention to be folded into a size substantially smaller than that of conventional foldable pet beds.

Another object of the present invention is to provide a foldable pet bed which can be easily folded in a compact size without involving any complicated mechanical process or equipments.

Another object of the present invention is to provide a foldable pet bed which is capable of providing a bed for pets with various sizes. In other words, the present invention facilitates widespread application thereof.

Another object of the present invention is to provide a foldable pet bed which does not involve complicated mechanical structure, so as to minimize the manufacturing cost and other related expenses of the present invention.

Accordingly, in order to accomplish the above objects, the present invention provides a foldable pet bed, comprising:

a pet bed top having a sized adapted for a pet resting thereon and comprising a first supporting panel and a second supporting panel aligned in an edge-to-edge manner to form a top resting surface for the pet resting thereon; and

a foldable bed frame, which comprises:

two elongated side reinforcing members extended underneath the pet bed top along two longitudinal sides thereof respectively,

two spaced apart leg frames pivotally coupling between the two side reinforcing members to pivotally fold between an unfolded position and a folded position, wherein at the unfolded up position, each of the leg frames is pivotally folded to perpendicular to the pet bed top, and at the folded position, the leg frames are pivotally folded to rest underneath the pet bed top;

means for retaining the leg frames at the folded position; and

two pivot joints provided at the side reinforcing members respectively at a position between the first and second supporting panels, wherein the first and second supporting panels are pivotally connected via the pivot joint in such a manner that the first and second supporting panels are pivotally to overlap with each other to pivotally fold up the pet bed top in half, so as to retain the leg frames between the first and second supporting panels.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a foldable pet bed according to a preferred embodiment of the present invention.

FIG. 2A to FIG. 2C are schematic diagrams of the foldable pet bed according to the above preferred embodiment of the present invention.

FIG. 3 is a first alternative mode of the foldable pet bed according to the above preferred embodiment of the present invention.

FIG. 4 is a schematic diagram of the first alternative mode of the foldable pet bed according to the above preferred embodiment of the present invention

FIG. 5 is a second alternative mode of the foldable pet bed according to the above preferred embodiment of the present invention.

### DETAILED DESCRIPTION OF THE PREFERRED EMBODIMENT

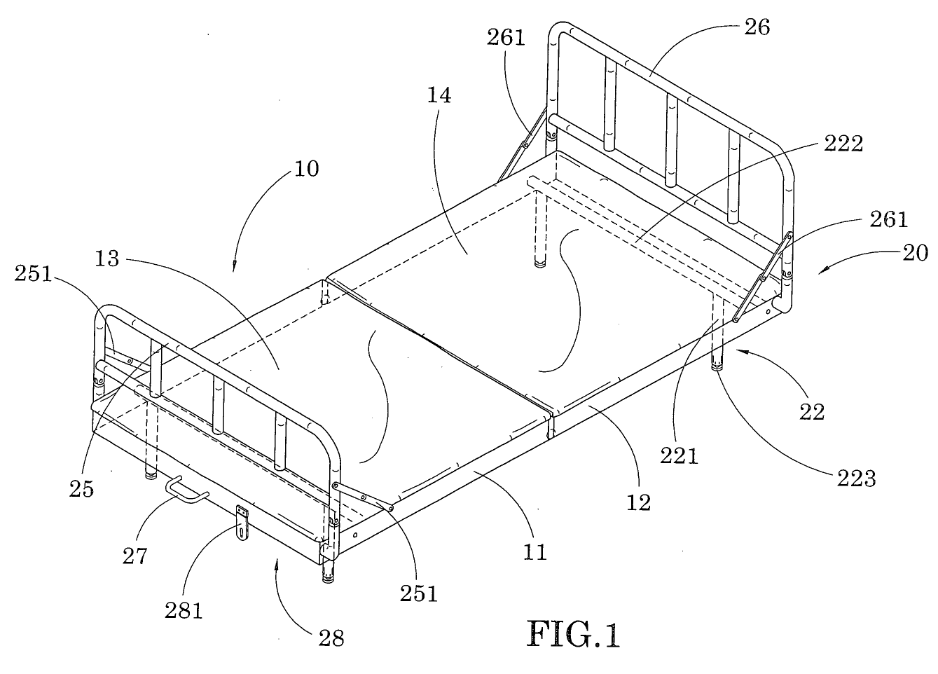

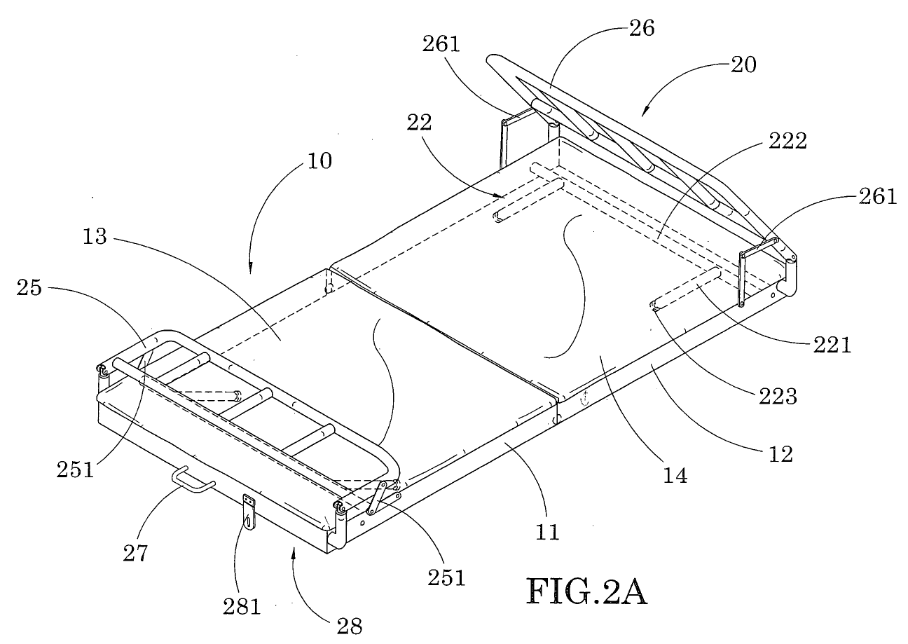

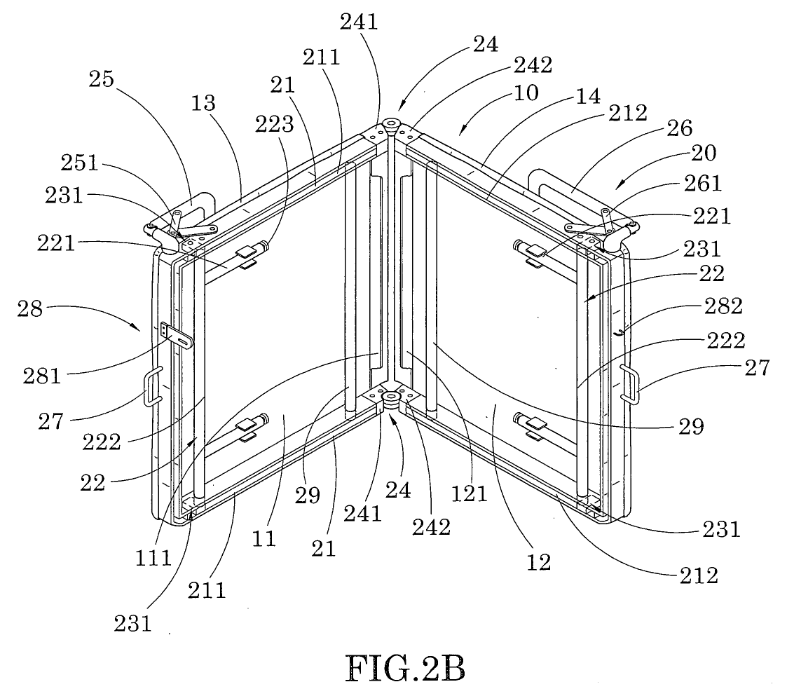

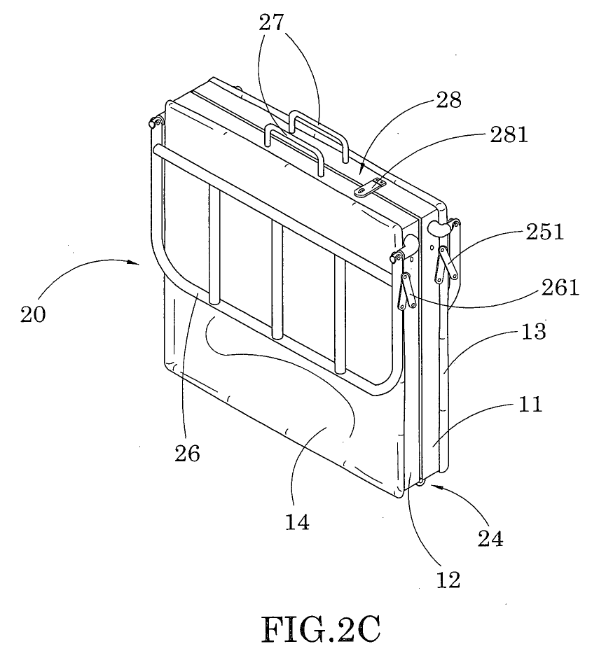

Referring to FIG. 1, FIG. 2A to FIG. 2C of the drawings, a foldable pet bed according to a preferred embodiment of the present invention is illustrated, in which the foldable bed pet comprises a pet bed top 10 and a foldable bed frame 20.

The pet bed top 10 has a size adapted for a pet resting thereon and comprising a first supporting panel 11 and a second supporting panel 12 aligned in an edge-to-edge manner to form a top resting surface for said pet resting thereon.

The foldable bed frame 20 comprises two elongated side reinforcing members 21, two leg frames 22, means for retaining the leg frames 22 at an unfolded position, and two pivot joints 24, wherein the two elongated side reinforcing members 21 are extended underneath the pet bed top 10 along two longitudinal sides thereof respectively.

The two spaced apart leg frames 22 are pivotally coupling between the two side reinforcing members 21 to pivotally fold between an unfolded position and a folded position, wherein at the unfolded position, each of the leg frames 22 is pivotally folded to perpendicular to the pet bed top 10, and at the folded position, the leg frames 22 are pivotally folded to rest underneath the pet bed top 10.

The two pivot joints 24 are provided at the side reinforcing members 21 respectively at a position between the first and the second supporting panels 11, 12, wherein the first and the second supporting panels 11, 12 are pivotally connected via the pivot joint 24 in such a manner that the first and the second supporting panels 11, 12 are pivotally fold to overlap with each other so as to pivotally fold up the pet bed top 10 in half, for retaining the leg frames 22 between the first and the second supporting panels 11, 12.

According to the preferred embodiment of the present invention, the pet bed top 10 further comprises a first and a second dirt-proof and waterproof cushion pad 13, 14 overlappedly provided on top of the first and the second supporting panels 11, 12 respectively for providing a cushioning effect to the pet resting on the pet bed top 10. Each of the first and the second cushion pads 13, 14 comprises an enclosure fabric defining a cushioning cavity, and a plurality of cushioning materials filled in the cushioning cavity on top of the respective first or the second supporting panels 11 (12) for importing an optimal comfort to the pet. In other words, when the first and second supporting panels 11, 12 are unfolded edge-to-edge, the cushion pads 13, 14 of the first and second supporting panels 11, 12 are aligned to form the top resting surface for the pet resting thereon.

The two elongated side reinforcing members 21 are spacedly provided underneath two sides of the pet bed top 10 for substantially supporting the pet bed top 10, wherein each of the elongated side reinforcing members 21 comprises a first and a second reinforcing runners 211, 212 each having an outer end portion and an inner end portion, wherein the inner end portion of the first reinforcing runner 211 is adapted to pivotally communicate with the inner end portion of the second reinforcing runner 212 via the respective pivot joint 24.

Accordingly, referring to FIG. 1, FIG. 2A to FIG. 2C of the drawings, each of the leg frames 22 comprises a plurality of supporting legs 221 and a transverse coupling member 222 extended across a transverse direction of the pet bed top 10 thereunder, and has two outer ends pivotally coupled with the outer portions of the respective reinforcing runners 211 (212) so as to foldably connect the respective leg frame 22 with the side reinforcing members 21. The supporting legs 221 are connected with the transverse coupling member 222 so that when the transverse coupling member 222 pivotally moves with respect to the pet bed top 10, the supporting legs 221 are driven to move pivotally with respect to the pet bed top 10 for folding between the folded position and unfolded position. Moreover, in order to allow the pet bed top 10 to be folded to form a compact structure, a length of the transverse coupling member 222 is smaller than a width of the first and the second supporting panel 11, 12 so that when the leg frames 22 are pivotally folded to the folded position, they are arranged to overlap with the first and the second supporting panels 11, 12 respectively.

In other words, each transverse coupling member 222 has two outer ends pivotally coupling with the two side reinforcing members 21 respectively and two supporting legs 221 extending from the transverse coupling member 222 in such a manner that when the leg frame 22 is folded at the unfolded position, the supporting legs 221 are perpendicularly and downwardly extended from the pet bed top 10, and when the leg frame 22 is folded at the unfolded position, the supporting legs 221 are folded between the two side reinforcing members 21 to rest underneath the pet bet top 10.

The foldable bed frame 20 further comprises a front boundary frame 25 and a rear boundary frame 26 upwardly and pivotally extended above the pet bed top 10 to define a resting area within two inner side of the front boundary frame 25 and the rear boundary frame 26, and the pet bed top 10 for a pet, such as a dog, resting therein. More specifically, each of the front boundary frame 25 and the rear boundary frame 26 has a predetermined height and a width smaller than a width of the first and the second supporting panel 11, 12, so that the front and the rear boundary frame 25, 26 are capable of folding towards the first and the second supporting panels 11, 12 respectively for forming a compact structure of the foldable pet bed.

It is important to point out at this stage that the foldable pet bed of the present invention is meant to be transported and carried conveniently. As a result, the foldable bed frame 20 further comprises a handling member 27, such as a handle bar, provided on an outer edge of the first and the second supporting panels 11, 12, in such a manner that when the foldable pet bed is folded to form a compact structure, the handling member 27 is adapted for allowing a user to grip thereon so as to easily and conveniently carry the foldable pet bed of the present invention to whatever destination to which the user is heading.

The means for retaining the leg frames 22 comprises a pivot leg locker 231 pivotally coupling with respective leg frame 22 and the pet bed top 10 respectively so as to substantially retain the leg frame 22 at the unfolded position. Specifically, the pivot leg locker 231 comprises two fold actuators coupled with two ends of the transverse coupling members 222 for holding the leg frames 22 in the unfolded position, as shown in FIG. 2B of the drawings. Moreover, the pet bed top 10 may further comprise two leg holders for retaining the leg frames 22 in the folded position. Alternatively, the pivot leg locker 231 may have two ends pivotally coupling with the respective leg frame 22 and the pet bed top 10 for retaining the leg frames 22 in the unfolded position.

Each of the pivot joints 24 comprises a first and a second joint members 241, 242 provided at inner sides of the respective first and second reinforcing runners 211, 212, wherein the first and the second joint members 241, 242 are pivotally connected with each other to form a pivot point underneath the pet bed top 10 for pivotally connecting the first supporting panel 11 with the second supporting panel 12.

More specifically, each of the first and the second supporting panels 11, 12 further comprises a flipping member 111 (121) downwardly extended from an inner side edge of the respective first and the second supporting panels 11, 12 to connect with the first and the second joint members 241, 242. As a result, the first and the second supporting panels 11, 12 are capable of folding towards each other about the pivot point.

In order to retain the foldable pet bed in a compact structure when the first and the second supporting panels 11, 12 and the leg frames 22 are pivotally and overlappedly folded towards each other, the foldable bed frame 20 further comprises a locking device 28 provided on the pet bed top 10 for detachably locking up the first and the second supporting panels 11, 12 with each other when the foldable pet bed is folded to form the compact structure. The locking device 28 comprises a first locking member 281 provided at the first supporting panel 11 and a second locking member 282 which is provided at the second supporting panel 12 and is detachably engaged with the first locking member 281 when the first and second supporting panels 11, 12 are pivotally folded in half.

Moreover, it is worth mentioning that the foldable pet bed further comprises a plurality of retention members 29 spacedly extended between the two side reinforcing members 21 at a position underneath the pet bed top 10 so as to substantially support the first and second supporting panels 11, 12. Moreover, each of the front and the rear boundary frames 25, 26 further comprises a retaining device 251, 261 pivotally coupling the front and the rear boundary frames 25, 26 with the pet bed top 10 for pivotally supporting the front and the rear boundary frames 25, 26 at the unfolded position.

Each of the leg frames 22 further comprises a ground-leveling adjustor 223 movably provided at a bottom end of each of the supporting legs 221 to selectively adjust the pet bed top 10 with respect to a ground level.

The operation of the present invention is as follows: the foldable pet bed is normally erected for a pet to rest on the pet bed top 10. When the user wishes to fold the foldable pet bed into a compact structure, he or she needs to fold the leg frames 22, the front and the rear boundary frames 25, 26 towards the pet bed top 10, and finally, the user should fold the first supporting panel 1I towards the second supporting panel 12 for reducing the overall size of the foldable pet bed into its minimal.

From the above descriptions, it can be anticipated that the foldable pet bed of the present invention can be used at home and during traveling, so that the pets enjoy the same level of comfort despite traveling around.

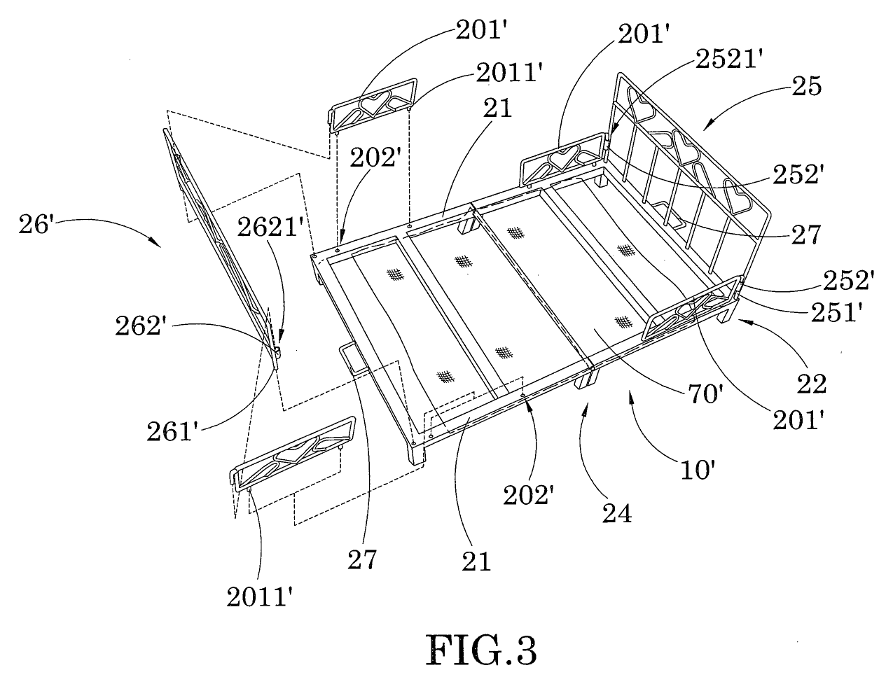

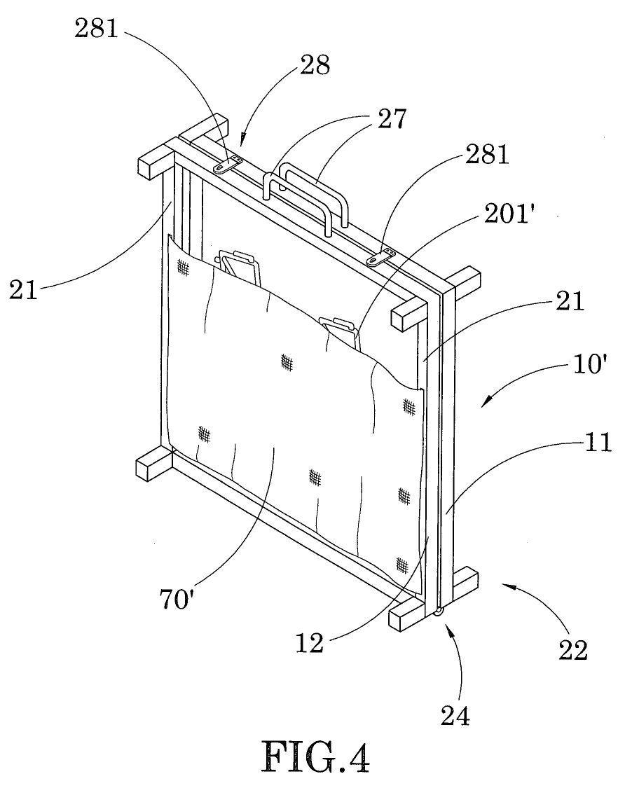

Referring to FIG. 3 to FIG. 4 of the drawings, a first alternative mode of the foldable pet bed according to the preferred embodiment of the present invention is illustrated. The first alternative mode is similar to the preferred embodiment, except the front and the rear boundary frame 25′, 26′. According to the first alternative mode, each of the front and the rear boundary frame 25′, 26′ is detachably attached on the foldable bed top 10′, whereas the foldable bed top 10′ further comprises a plurality of side boundary frames 201′, each having a predetermined length, detachably attached on two sides of the foldable bed top 10′ for further establishing side boundaries of the foldable bed top 10′.

According to the first alternative mode, each of the front and the rear boundary frames 25′, 26′ and the side boundary frames 201′ further has a plurality of attaching legs 251′ (261′) (2011′) downwardly extended therefrom, whereas the foldable bed frame 20′ further has a plurality of attachment holes 202′ spacedly formed thereon to align with the attaching legs 251′ (261′) (2011′) respectively, wherein the front and the rear boundary frame 25′, 26′ and the side boundary frames 201′ are detachably attached onto the foldable bed top 10′ at the respective attachment holes 202′. As a result, when the foldable pet bed is not in use, the front boundary frame 25′, the rear boundary frame 26′, an the side boundary frames 201′ are capable of being detached from the foldable bed frame 20′, which is then folded to form a compact structure.

In order to further enhance the attachment at the side boundary frames 201′, each of the front and the rear boundary frames 25′, 26′ further comprises a side frame connector 252′, 262′ each of which has a through connecting hole 2521′, 2621′ formed thereon, while each of the side boundary frames 201′ further has a mounting hook 2012′ extended from an outer side portion thereof, in such a manner that when the side boundary frame 201′ is attached on the foldable bed top 10′, the mounting hook 2012′ is arranged to insert into the respective connecting hole 2521′ (2621′) the front or the rear boundary frame 25′, 26′ so as to detachably connect the side boundary frame 201′ with the respective front and the rear boundary frame 25′, 26′.

According, the foldable pet bed further comprises a storage pocket 70′ provided underneath the foldable bed top 10′ in such a manner that the front and the rear boundary frame 25′, 26′, and the side boundary frames 201′ are adapted to be stored by the storage pocket 70′ when they are detached from the foldable bed top 10′. Thus, the foldable pet bed is easy for carrying and being transported when it is not in use.

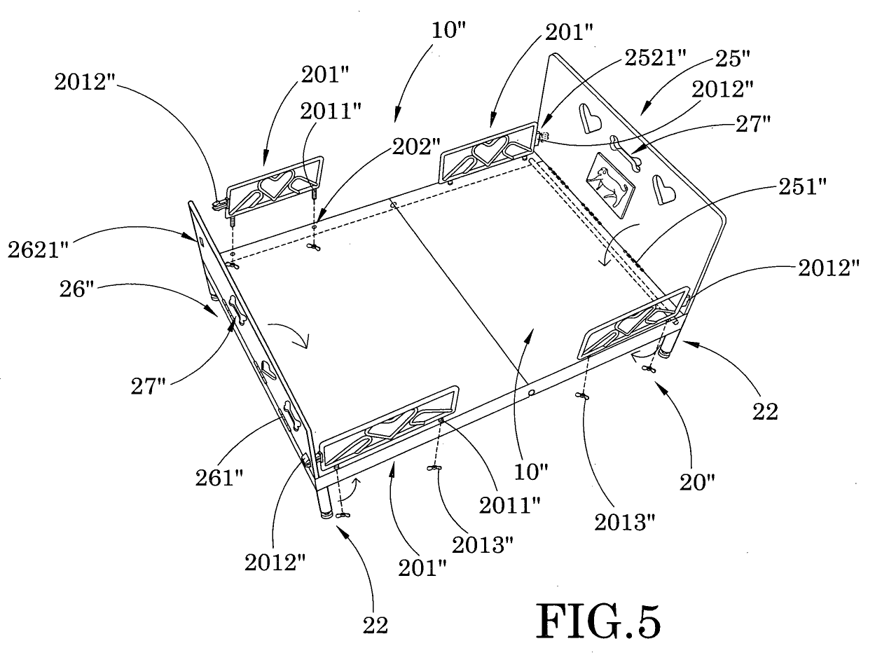

Referring to FIG. 5 of the drawings, a second alternative mode of the foldable pet bed according to the preferred embodiment of the present invention is illustrated. The second alternative mode is similar to the preferred embodiment except the front boundary frame 25″, the rear boundary frame 26″, and the side boundary frames 201″. According to the second alternative mode, each of the front and the rear boundary frames 25″, 26″ comprises a boundary panel made by wood or plastic materials, and a plurality of folding hinges 251″, 261″ mounted between the respective front and the rear boundary frame 25″, 26″ and the foldable bed top 10″ for pivotally coupling the front and the rear boundary frame 25″, 26″ with the foldable bed top 10″ in such a manner that the front and the rear boundary frames 25″, 26″ are adapted to be folded or unfolded with respect to the foldable bed top 10″.

As in the first alternative mode, the side boundary frames 201″ in this second alternative mode has a plurality of attaching legs 2011″ downwardly, each having a threaded portion, extended therefrom, whereas the foldable bed frame 20″ further has a plurality of attachment holes 202″ spacedly formed thereon to align with the attaching legs 2011′ respectively. As a result, when the foldable pet bed is not in use, the side boundary frames 201″ is capable of being detached from the foldable bed frame 20″, which is then folded to form a compact structure. Each of the side boundary frames 201″ further comprises a plurality of screw locker 2013″ detachably attached on the corresponding threaded portion of the attaching legs 2011″ for selectively locking the side boundary frame 201″ with the foldable bed frame 20″.

In order to further enhance the attachment at the side boundary frames 201″, the foldable bed frame 20″ further comprises a side frame connection arrangement which has a plurality of through connecting hole 2521″, 2621″ formed on the front and the rear boundary frame 25″, 26″ respectively, and a plurality of elastic mounting hook 2012″ extended from an outer side portion of the two side boundary frames 201″ respectively, in such a manner that when the side boundary frames 201″ are attached on the foldable bed frame 20″, the mounting hooks 2012″ are arranged to insert into the respective connecting hole 2521″ (2621″) of the front or the rear boundary frame 25″, 26″ so as to detachably connect the side boundary frame 201″ with the respective front and the rear boundary frame 25′, 26″.

Moreover, the handling members 27″ as a plurality of through handling slots formed on the front and the boundary member 25″, 26″ for allowing a user of the present invention to grip on the handling slot for conveniently carrying the foldable pet bed.

Finally, it is worth mentioning that the foldable pet bed of the present invention may be incorporated by a plurality of aesthetic accessories, such as picture frames, sculptures, and the likes.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A foldable pet bed, comprising:
a pet bed top having a sized adapted for a pet resting thereon and comprising a first supporting panel and a second supporting panel aligned in an edge-to-edge manner to form a top resting surface for said pet resting thereon; and
a foldable bed frame, which comprises:
two elongated side reinforcing members extended underneath said pet bed top along two longitudinal sides thereof respectively,
two spaced apart leg frames pivotally coupling between said two side reinforcing members to pivotally fold between an unfolded position and a folded position, wherein at said unfolded up position, each of said leg frames is pivotally folded to perpendicular to said pet bed top, and at said folded position, said leg frames are pivotally folded to rest underneath said pet bed top;
means for retaining said leg frames at said unfolded position; and
two pivot joints provided at said side reinforcing members respectively at a position between said first and second supporting panels, wherein said first and second supporting panels are pivotally connected via said pivot joint in such a manner that said first and second supporting panels are pivotally to overlap with each other to pivotally fold up said pet bed top in half, so as to retain said leg frames between said first and second supporting panels.

2. The foldable pet bed, as recited in claim 1, wherein each of said first and second supporting panels comprises a dirt-proof and waterproof cushion pad provided thereon such that when said first and second supporting panels are folded edge-to-edge, said cushion pads of said first and second supporting panels are aligned to form said top resting surface for said pet resting thereon.

3. The foldable pet bed, as recited in claim 1, wherein each of said side reinforcing members comprises first and second reinforcing runners which are mounted underneath said first and second supporting panels respectively and are pivotally connected by said respective pivot joint in an end-to-end manner in such a manner that said first and second reinforcing runners are pivotally folded to align end-to-end to form an elongated structure so as to support said pet bed top.

4. The foldable pet bed, as recited in claim 2, wherein each of said side reinforcing members comprises first and second reinforcing runners which are mounted underneath said first and second supporting panels respectively and are pivotally connected by said respective pivot joint in an end-to-end manner in such a manner that said first and second reinforcing runners are pivotally folded to align end-to-end to form an elongated structure so as to support said pet bed top.

5. The foldable pet bed, as recited in claim 2, wherein each of said leg frames comprises a transverse coupling member having two outer ends pivotally coupling with said two side reinforcing members respectively and two supporting legs spacedly extended from said transverse coupling member in such a manner that when said leg frame is folded at said unfolded position, said supporting legs are perpendicularly and downwardly extended from said pet bed top, and when said leg frame is folded at said unfolded position, said supporting legs are folded between said two side reinforcing members to rest underneath said pet bet top.

6. The foldable pet bed, as recited in claim 4, wherein each of said leg frames comprises a transverse coupling member having two outer ends pivotally coupling with said two side reinforcing members respectively and two supporting legs spacedly extended from said transverse coupling member in such a manner that when said leg frame is folded at said unfolded position, said supporting legs are perpendicularly and downwardly extended from said pet bed top, and when said leg frame is folded at said unfolded position, said supporting legs are folded between said two side reinforcing members to rest underneath said pet bet top.

7. The foldable pet bed, as recited in claim 5, wherein each of said leg frames further comprises two leg holders provided underneath said first and second supporting panels respectively at a position that when said leg frames are at said folded position, said supporting legs are engaged with said leg holders so as to substantially retain said leg frame at said folded position.

8. The foldable pet bed, as recited in claim 6, wherein each of said leg frames further comprises two leg holders provided underneath said first and second supporting panels respectively at a position that when said leg frames are at said folded position, said supporting legs are engaged with said leg holders so as to substantially retain said leg frame at said folded position.

9. The foldable pet bed, as recited in claim 7, wherein each of said leg frames further comprises a ground-leveling adjustor movably provided at a bottom end of each of said supporting legs to selectively adjust said pet bed top with respect to a ground level.

10. The foldable pet bed, as recited in claim 8, wherein each of said leg frames further comprises a ground-leveling adjustor movably provided at a bottom end of each of said supporting legs to selectively adjust said pet bed top with respect to a ground level.

11. The foldable pet bed, as recited in claim 4, further comprising front and rear boundary frames pivotally connecting with said first and second supporting panels respectively to form said top resting surface between said front and rear boundary frames, wherein said front and rear boundary frames are pivotally folded to overlap on said first and second supporting panels to form a compact structure.

12. The foldable pet bed, as recited in claim 10, further comprising front and rear boundary frames pivotally connecting with said first and second supporting panels respectively to form said top resting surface between said front and rear boundary frames, wherein said front and rear boundary frames are pivotally folded to overlap on said first and second supporting panels to form a compact structure.

13. The foldable pet bed, as recited in claim 4, further comprising a first locking member provided at said first supporting panel and a second locking member which is provided at said second supporting panel and is detachably engaged with said first locking member when said first and second supporting panels are pivotally folded in half.

14. The foldable pet bed, as recited in claim 12, further comprising a first locking member provided at said first supporting panel and a second locking member which is provided at said second supporting panel and is detachably engaged with said first locking member when said first and second supporting panels are pivotally folded in half.

15. The foldable pet bed, as recited in claim 4, further comprising a handling member provided on an outer edge of said first and said second supporting panels in such a manner that when said foldable pet bed is folded to form a compact structure, said handling member is adapted for allowing a user to grip thereon for easy and convenient carrying.

16. The foldable pet bed, as recited in claim 14, further comprising a handling member provided on an outer edge of said first and said second supporting panels in such a manner that when said foldable pet bed is folded to form a compact structure, said handling member is adapted for allowing a user to grip thereon for easy and convenient carrying.

17. The foldable pet bed, as recited in claim 8, wherein said retaining means comprises a pivot leg locker coupling with respective leg frame and said pet bed top respectively so as to substantially retain said leg frame at said unfolded position.

18. The foldable pet bed, as recited in claim 16, wherein said retaining means comprises a pivot leg locker coupling with respective leg frame and said pet bed top respectively so as to substantially retain said leg frame at said unfolded position.

19. The foldable pet bed, as recited in claim 4, further comprising a plurality of retention members spacedly extended between said two side reinforcing members at a position underneath said pet bed top so as to substantially support said first and second supporting panels.

20. The foldable pet bed, as recited in claim 18, further comprising a plurality of retention members spacedly extended between said two side reinforcing members at a position underneath said pet bed top so as to substantially support said first and second supporting panels.

21. The foldable pet bed, as recited in claim 4, further comprising front and rear boundary frames detachably connecting with said first and second supporting panels respectively to form said top resting surface between said front and rear boundary frames, wherein said front and rear boundary frames are detached and properly stored to allow said first and second supporting panels to form a compact structure.

22. The foldable pet bed, as recited in claim 10, further comprising front and rear boundary frames detachably connecting with said first and second supporting panels respectively to form said top resting surface between said front and rear boundary frames, wherein said front and rear boundary frames are detached and properly stored to allow said first and second supporting panels to form a compact structure.

23. The foldable pet bed, as recited in claim 21, wherein said foldable bed top further comprises a plurality of side boundary frames, each having a predetermined length, detachably attached on two sides of said foldable bed top for establishing side boundaries of said foldable bed top.

24. The foldable pet bed, as recited in claim 22, wherein said foldable bed top further comprises a plurality of side boundary frames, each having a predetermined length, detachably attached on two sides of said foldable bed top for establishing side boundaries of said foldable bed top.

25. The foldable pet bed, as recited in claim 23, wherein each of said front and said rear boundary frames and said side boundary frames further has a plurality of attaching legs downwardly extended therefrom, whereas said foldable bed frame further has a plurality of attachment holes spacedly formed thereon to align with said attaching legs respectively, wherein said attaching legs are detachably inserted into said attachment holes respectively for detachably attaching said front boundary frame, said rear boundary frame, and said side boundary frames onto said foldable bed top.

26. The foldable pet bed, as recited in claim 24, wherein each of said front and said rear boundary frames and said side boundary frames further has a plurality of attaching legs downwardly extended therefrom, whereas said foldable bed frame further has a plurality of attachment holes spacedly formed thereon to align with said attaching legs respectively, wherein said attaching legs are detachably inserted into said attachment holes respectively for detachably attaching said front boundary frame, said rear boundary frame, and said side boundary frames onto said foldable bed top.

27. The foldable pet bed, as recited in claim 25, further comprising a storage pocket provided underneath said foldable bed top in such a manner that said front and said rear boundary frame, and said side boundary frames are adapted to be stored by said storage pocket when said front boundary frame, said rear boundary frame and said side boundary frames are detached from said foldable bed top.

28. The foldable pet bed, as recited in claim 26, further comprising a storage pocket provided underneath said foldable bed top in such a manner that said front and said rear boundary frame, and said side boundary frames are adapted to be stored by said storage pocket when said front boundary frame, said rear boundary frame and said side boundary frames are detached from said foldable bed top.

29. The foldable pet bed, as recited in claim 4, further comprising a front and a rear boundary frame each of which comprises a boundary panel, and a plurality of folding hinges mounted between said respective front and said rear boundary frame, and said foldable bed top for pivotally coupling said front and said rear boundary frame with said foldable bed top in such a manner that said front and said rear boundary frames are adapted to be folded or unfolded with respect to said foldable bed top.

30. The foldable pet bed, as recited in claim 29, wherein each of said side boundary frames has a plurality of attaching legs, each having a threaded portion, downwardly extended therefrom, whereas said foldable bed frame further has a plurality of attachment holes spacedly formed thereon to align with said attaching legs respectively, and a plurality of screw lockers detachably attached on said corresponding threaded portion of said attaching legs when said attaching legs pass through said attachment holes, so that said screw lockers are adapted to selectively lock up said attaching legs with said attachment holes for selectively locking said side boundary frame with said foldable bed frame.

31. The foldable pet bed, as recited in claim 30, wherein said foldable bed frame further comprises a side frame connection arrangement which has a plurality of through connecting holes formed on said front and said rear boundary frame respectively, and a plurality of elastic mounting hooks extended from an outer side portion of said two side boundary frames respectively, in such a manner that when said side boundary frames are attached on said foldable bed frame, said mounting hooks are arranged to detachably insert into said respective connecting hole of said front and said rear boundary frame so as to detachably connect said side boundary frame with the respective to said front and said rear boundary frame.
